(19) United States
(12) Patent Application Publication
(10) Pub. No.: US 2019/0226894 A1
(43) Pub. Date: Jul. 25, 2019

(54) METHOD AND APPARATUS FOR DETERMINING A CORRECTED VALUE FOR THE VISCOSITY-DEPENDENT SONIC VELOCITY IN A FLUID TO BE TESTED

(71) Applicant: ANTON PAAR GMBH, GRAZ-STRASSGANG (AT)

(72) Inventors: STEFAN ROSSEGGER, GRAZ (AT); ROBERT BREIDLER, KINDBERG (AT); ROBERT AMSUESS, FELDKIRCHEN BEI GRAZ (AT); LUKAS SCHANTL, GRAZ (AT)

(21) Appl. No.: 16/256,312

(22) Filed: Jan. 24, 2019

(30) Foreign Application Priority Data
Jan. 24, 2018 (AT) A50062/2018

(51) Int. Cl. G01F 1/66; G01F 25/00

(52) U.S. Cl. CPC G01F 1/668; G01F 25/0007

(57) ABSTRACT

A method for determining a corrected value for a viscosity-dependent sonic velocity in a fluid under test includes generating and transmitting sound pulses to the fluid under test, registering the sound pulses after traversing a predetermined measuring distance in the fluid under test, and ascertaining a first arrival of a first sound pulse received after traversing the measuring distance and determining the transit time of the first received sound pulse in the fluid under test. A viscosity is predetermined or ascertained for the fluid under test, and a transit time of the first received sound pulse and the viscosity are used to determine the sonic velocity in the fluid under test. An apparatus for determining a corrected value for a viscosity-dependent sonic velocity in a fluid under test is also provided.

### CROSS-REFERENCE TO RELATED APPLICATION

This application claims the priority, under 35 U.S.C. § 119, of Austrian Patent Application A50062/2018, filed Jan. 24, 2018; the prior application is herewith incorporated by reference in its entirety.

### BACKGROUND OF THE INVENTION

### Field of the Invention

The invention relates to a method for determining a corrected value for a viscosity-dependent sonic velocity in a fluid under test, which includes generating and transmitting sound pulses to the fluid under test, registering the sound pulses after traversing a predetermined measuring distance in the fluid under test, obtaining a first arrival of a first sound pulse received after traversing the measuring distance, and determining a transit time of the first received sound pulse in the fluid under test. The invention also relates to an apparatus for determining a corrected value for a viscosity-dependent sonic velocity in a fluid under test, which includes a sound pulse generator for emitting sound pulses, a sound pulse receiver for registering incoming sound pulses, a measuring cell defining a predetermined measuring distance in the measuring cell between the sound pulse generator and the sound pulse receiver, and an evaluation unit connected to the sound pulse generator and to the sound pulse receiver.

The prior art teaches various devices for determining the sonic velocity in fluids. In such devices, sound pulses are transmitted, for example, by a solid-fluid-solid layer sequence, and the sonic velocity is calculated from the transit time taken for the pulses to pass through the fluid layer. Devices for determining the sonic velocity are also known, in which sound pulses impinge on a boundary surface between solid and fluid, and the component of the sound pulse reflected at the boundary surface is examined.

In the case of laboratory measurements, it is desirable to conduct sonic velocity measurements in a support structure and on samples that are as small as possible, e.g. in flow cells or sample containers having small dimensions. A drawback of the methods known from the prior art is that processes or fluid properties, such as the viscosity, which cause energy dissipation or attenuation upon passage of a sound pulse through a fluid, are not taken into account in determining the sonic velocity. That distorts the determined sound propagation time, particularly in the case of a small measuring cell size or a short measuring distance.

### SUMMARY OF THE INVENTION

It is accordingly an object of the invention to provide a method and an apparatus for determining a corrected value for the viscosity-dependent sonic velocity in a fluid to be tested, which overcome the hereinafore-mentioned disadvantages of the heretofore-known methods and apparatuses of this general type and which provide a simple and approximate correction of a measurement error caused by the viscosities of a fluid under test in determining the sound propagation time.

With the foregoing and other objects in view there is provided, in accordance with the invention, a method for determining a corrected value for the viscosity-dependent sonic velocity in a fluid under test, wherein:

sound pulses are generated and transmitted to the fluid under test,

the sound pulses are registered after traversing a predetermined measuring distance in the fluid under test,

the first arrival of the first sound pulse received after traversing the measuring distance is obtained, and the transit time of the first received sound pulse in the fluid under test is ascertained;

a viscosity for the fluid under test is predetermined or ascertained, and

the transit time of the first received sound pulse and the viscosity are used to determine the sonic velocity in the fluid under test.

In a method according to the invention for determining the sonic velocity in the fluid under test as accurately as possible, it may be provided that:

a first correction table is provided for the relationship between the viscosity and the deviation in the first arrival of the first received sound pulse for fluids each having a known viscosity,

a correction is made with regard to the viscosity, by using the first correction table and the predetermined or ascertained viscosity, with respect to the first arrival during measurement of the first received sound pulse for the fluid under test, and

the sonic velocity in the fluid under test is calculated from the corrected transit time of the first received sound pulse and the predetermined measuring distance.

In an alternative embodiment of the invention, to determine the sonic velocity in a fluid under test particularly simply and accurately, it may be provided that:

a first calibration table is prepared for the first arrival of the first received sound pulse for fluids that each have a known sonic velocity and known viscosity, and

the first arrival of the first received sound pulse and the predetermined or ascertained viscosity are used to determine the sonic velocity in the fluid under test by using the first calibration table.

In order to be able to determine the transit time of the sound pulse with sufficient accuracy, it may be provided that the first arrival of the first received sound pulse is ascertained as:

the first zero crossing of the sound pulse after the first registered maximum of the sound pulse, or

the first registered arrival of the sound pulse, or

the peak position of the first maximum of the first registered sound pulse.

In order to ensure a simple and exact correction of the viscosity-induced measurement error to the sonic velocity or the transit time of the sound pulse, it may be provided that:

a known viscosity or known viscosity range is predetermined for the fluid under test, or

a database of known viscosities or viscosity ranges for fluids is prepared, and the viscosity or a known range of viscosities are ascertained for the fluid under test in the database.

In order to be able to use particularly precise viscosity data for the fluid under test for the correction, it may be provided that the viscosity for the fluid under test is ascertained by using a measurement method for determining the viscosity, in particular by using a flexural resonator.

A simple method may be provided for determining the viscosity based on the transit time of the sound pulse, using the relationship between the pulse width of the first received sound pulse and the viscosity, in which:

a second calibration table is provided for the relationship between the viscosity and the pulse width of the first sound pulse that was received after traversing the measuring distance, for fluids that have a respectively known viscosity,

the pulse width of the first sound pulse received in the fluid under test after traversing the measuring distance is ascertained, and

the viscosity of the fluid under test is determined by using the second calibration table and the ascertained pulse width of the first received sound pulse.

In order to be able to determine the pulse width with sufficient accuracy, it may be provided that the pulse width of the first received sound pulse is ascertained as:

the time period between first receiving the sound pulse and the first registered zero crossing of the sound pulse, or

the full width at half maximum of the first received sound pulse.

In order to take into account the influence of the temperature simultaneously with the influence of the viscosity on the transit time of a sound pulse in ascertaining a corrected value for the sonic velocity, it may be provided that:

either the first correction table, for the relationship between the viscosity and the first arrival deviation, or the first calibration table for the first arrival of the first received sound pulse for fluids that each have a known sonic velocity and known viscosity, is prepared for different temperatures,

the temperature of the fluid under test is ascertained during measurement, and

the temperature is taken into account in correcting the sonic velocity value obtained by measurement by using the first correction table or the first calibration table.

In order to obtain a corrected value for the viscosity-dependent sonic velocity from the measurement of the transit time of a sound pulse in a fluid under test in a particularly simple way, it may be provided in a method according to the invention that:

the first correction table for the relationship between the viscosity and the first setpoint deviation, and the second calibration table for the relationship between the viscosity and the pulse width, are used to create a common correction table, wherein

the first arrival deviation is ascertained based on the pulse width that has been ascertained for the fluid under test and the common correction table, and

the sonic velocity in the fluid under test is calculated from the corrected transit time of the first received sound pulse and the predetermined measuring distance, or

the first calibration table, for the first arrival of the first received sound pulse for fluids of known sonic velocity and known viscosity and the second calibration table for the relationship between the viscosity and the pulse width for fluids with respectively known viscosity, are used to create a common correction table,

the first arrival of the first received sound pulse determined for the fluid under test, and the pulse width determined for the fluid under test, are used to determine the sonic velocity by using the common correction table.

Since large measurement errors occur when measuring fluids with high viscosity, and the total signals for measuring cells of small size cannot be evaluated, it may be provided that the viscosity of the fluid under test is greater than 1000 mPa·s and/or that the measuring distance is less than 1 cm.

With the objects of the invention in view, there is also provided an apparatus for determining a corrected value for the viscosity-dependent sonic velocity in a fluid under test, comprising:

a sound pulse generator for emitting sound pulses and a sound pulse receiver for registering incoming sound pulses,

a measuring cell having a predetermined measuring distance disposed therein between the sound pulse generator and the sound pulse receiver, and

an evaluation unit connected to the sound pulse generator and the sound pulse receiver, the evaluation unit being configured to carry out a method according to the invention.

In order to take into account the temperature when determining a corrected value for the viscosity-dependent sonic velocity, it may be provided that a sensor connected to the evaluation unit is provided for determining the temperature of the fluid under test.

In order to provide an apparatus according to the invention having a particularly compact construction, it may be provided that:

the sound pulse generator and the sound pulse receiver are configured as a combined sound pulse generator/receiver, which is disposed at one end of the measuring distance,

the sound pulse generator/receiver is disposed opposite a sound-reflecting interface at the far end of the measuring distance, and

the sound pulse generator/receiver may be excited by the registration of incoming sound pulses to emit sound pulses.

Other features which are considered as characteristic for the invention are set forth in the appended claims.

Although the invention is illustrated and described herein as embodied in a method and an apparatus for determining a corrected value for the viscosity-dependent sonic velocity in a fluid to be tested, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings. Further advantages and configurations of the invention will become apparent from the description and the accompanying drawings. Particularly advantageous but non-limiting embodiments of the invention are illustrated schematically below, with reference to the accompanying drawings, and are described by way of example with reference to the drawings.

### BRIEF DESCRIPTION OF THE SEVERAL VIEWS OF THE DRAWING

FIG. 1 is a diagrammatic, partly-sectional view of the structure of a sound measuring cell according to the invention;

FIG. 2 is a diagram showing a received signal for a fluid;

FIG. 3 is a diagram showing receiving signals from two fluids with different viscosity;

FIG. 4 is a diagram showing the received signal from FIG. 2 with a registered pulse width;

FIG. 5 is a diagram showing the received signals from FIG. 3 with registered pulse widths;

FIG. 6 is a diagram showing the deviation of the transit time of the sound pulse relative to the viscosity;

FIG. 7 is a diagram showing the relationship between the pulse width and the viscosity; and

FIG. 8 is a diagram showing the deviation of the sonic velocity relative to the viscosity.

### DETAILED DESCRIPTION OF THE INVENTION

Referring now in detail to the single figure of the drawing, there is seen an apparatus 10 according to the invention for determining a corrected value for the viscosity-dependent sonic velocity in a fluid 1 under test. The apparatus 10 includes a measuring cell 5, in which the fluid 1 under test is located, a sound pulse generator 2 for emitting sound pulses, and a sound pulse receiver 3 for registering incoming sound pulses. The sound pulse generator 2 and the sound pulse receiver 3 are disposed laterally on the outside of the measuring cell 5, so that they face each other. A suitable sound pulse generator 2, for example, is a piezoelectric ultrasonic signal generator and a suitable sound pulse receiver 3 is a corresponding ultrasonic signal receiver.

A measuring distance 4 is disposed between the sound pulse generator 2 and the sound pulse receiver 3 in the measuring cell 5, and an evaluation unit 6 is connected to the sound pulse generator 2 and the sound pulse receiver 3. In order to prevent interference with the sound pulse or received signal arriving at the sound pulse receiver 3 by structure-borne sound waves, the measuring distance 4 is chosen so that the path between the sound pulse generator 2 and the sound pulse receiver 3 is significantly longer over the solid portion.

In the embodiment shown, the evaluation unit 6 controls the sound pulse generator 2 to emit sound pulses at predetermined times, and the evaluation unit 6 receives and evaluates the data provided by the sound pulse receiver 3. The evaluation unit 6 is configured to carry out a method according to the invention for determining a corrected value for the viscosity-dependent sonic velocity, which will be discussed in more detail below. Alternatively, in an apparatus 10 according to the invention, the evaluation unit 6 may also have a separate control or electronic unit.

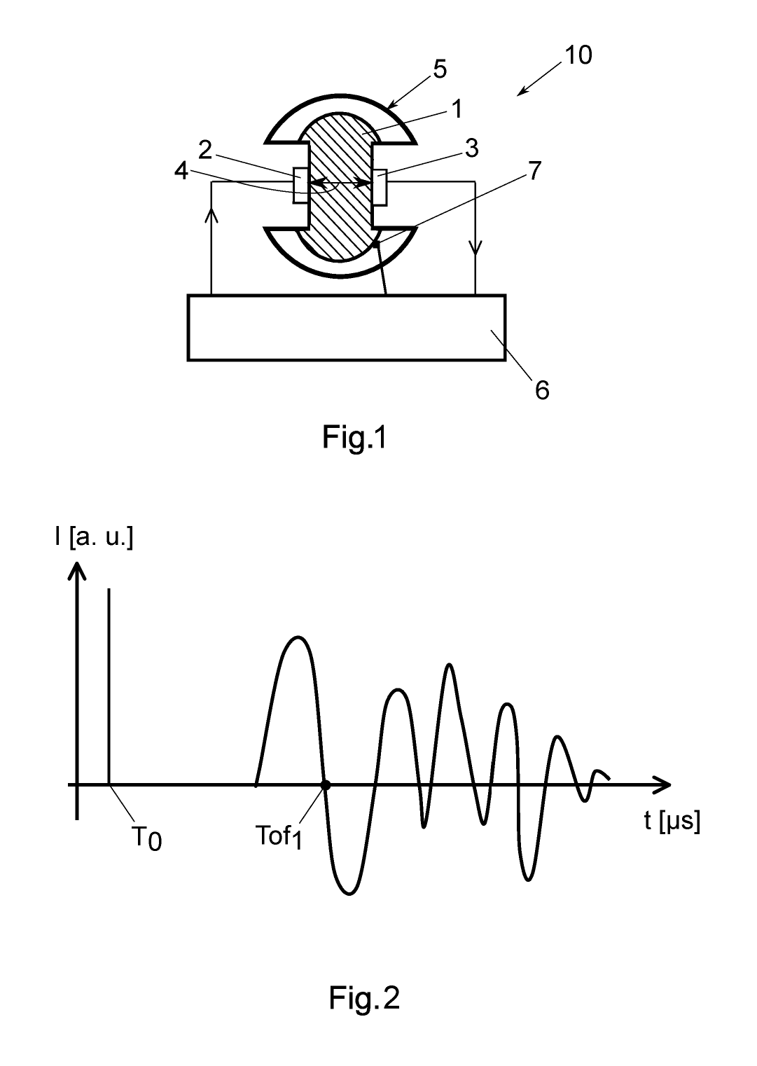

In the exemplary embodiment shown in FIG. 1, a temperature sensor 7 for determining the temperature of the fluid 1 under test is furthermore disposed on the measuring cell 5 and connected to the evaluation unit 6.

An apparatus 10 according to the invention, configured in this way, may be used, for example, for determining the sound propagation time in a fluid, for example while the fluid is flowing through a tube. In this case, the tube is to be regarded as the measuring cell 5 in which the fluid 1 under test is located. The sound pulse generator 2 and sound pulse receiver 3 are disposed opposite each other on the outer surfaces of the pipe.

Alternatively, an apparatus 10 according to the invention may also be used for installation in process lines, the process line in this case serving as the measuring cell 5. In this case, the sound pulse generator 2 and sound pulse receiver 3 are disposed on a fork-shaped part having small dimensions, and are located across from each other on that part.

An apparatus 10 according to the invention is also suitable for carrying out laboratory measurements using sample quantities that are as small as possible. In this case, the measuring cell 5, for example a flow measuring cell or a sample container, is used with small dimensions in a supporting construction, in order to store a fluid 1 under test therein.

In the embodiment shown in FIG. 1, the evaluation unit 6 controls the sound pulse generator 2, so that sound pulses are emitted from the sound pulse generator 2. The sound pulses are sent through a solid-fluid-solid layer sequence, and in each case the outer walls of the measuring cell 5 represent the solid. The sound pulses are registered after traversing the predetermined measuring distance 4 in the fluid 1 under test from the sound pulse receiver 3, whereupon the first arrival Tof1, Tof2 (FIG. 2) of the first pulse received after traversing the measuring distance 4 is ascertained, and the transit time of the first received sound pulse under test fluid 1 is determined, by the evaluation unit 6.

FIG. 2 shows an example of a received signal in a fluid 1 under test, wherein the signal intensity I is plotted in arbitrary units [au] on the y-axis against the transit time t in μs on the x-axis. The transit time of the sound pulse is considered to be that period of time that elapses between the excitation time T₀ at which the sound pulse generator 2 emits a sound pulse and the first arrival Tof1, at which the sound pulse receiver 3 registers the first sound pulse received after traversing the measuring distance 4.

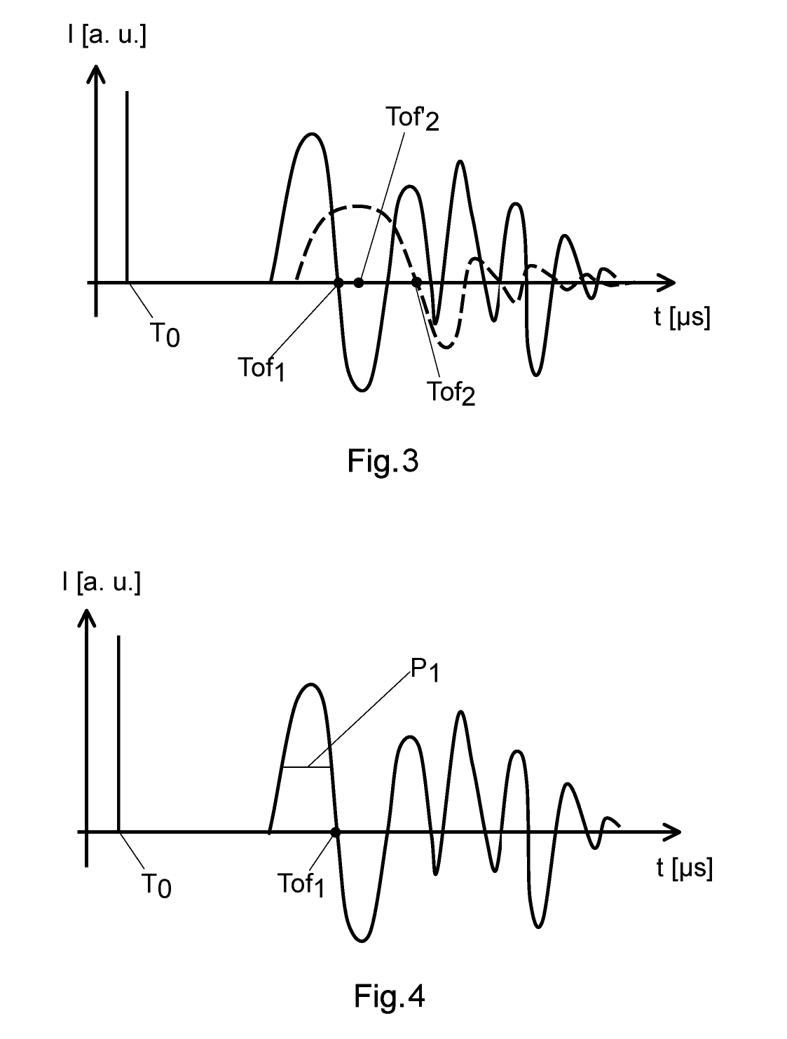

In this case, a first arrival Tof1, Tof2 may be defined as the first zero crossing by the first sound pulse received at the sound pulse receiver 3, which is registered after the first registered maximum of the sound pulse, as shown in FIGS. 3 to 5. Defined in this way, the first arrival at the sound pulse receiver 3 may be determined particularly exactly.

Alternatively, the first arrival Tof1, Tof2 may be defined as the first registered arrival of the sound pulse at the sound pulse receiver 3, or the peak position of the first maximum of the first sound pulse arriving at the sound pulse receiver 3.

In substance, the sonic velocity of the fluid 1 under test may be calculated from this transit time of the sound pulse and the measuring distance 4. The actual transit time is characterized by the first increase of the signal at the receiver. If, as in the exemplary embodiment shown schematically in FIG. 3, the first zero crossing Tof1 is selected as the first arrival for evaluation, the transit time is still corrected by the amount of the pulse width P1 (see FIG. 4).

The sonic velocity results, for example, from the measuring distance 4 divided by the actual transit time of the sound pulse. Because the start signal of the received sound pulse, i.e. the start of registration of the received signal, often cannot be determined with sufficient accuracy, the first arrival Tof1 of the first received sound pulse is ascertained as the first registered zero crossing of the received sound pulse.

The sonic velocity when sound pulses propagate in a fluid is a materials parameter and may be used for materials characterization. For many liquid solutions and mixtures, the sonic velocity is directly proportional to the concentration of the components and may therefore be advantageously used for determining concentration in, for example, two-component systems. As a further materials parameter, density may be ascertained from a determination of the sonic velocity with the aid of the relationship between the sonic velocity in a fluid and the fluid's compressibility and density.

Therefore, in order to characterize the materials parameters of a fluid 1 under test as accurately as possible, it is desirable to determine the sonic velocity in the fluid 1 under test as exactly as possible. When a sound pulse passes through the fluid 1 under test, it is attenuated by different processes that cause energy dissipation. The frequency composition of the sound pulse is varied by the fluid 1 and the boundary surfaces traversed, while high viscosities η increase the attenuation and thus magnify the variation in the frequency composition.

The sound pulse arriving at the sound pulse receiver 3 is therefore a superposition of different sound phase velocities at different frequencies with different amplitudes, which cannot be completely recorded and analyzed.

FIG. 3 schematically shows received sound pulses for the fluid 1 under test shown in FIG. 2, with an additional fluid having a lower sonic velocity and a higher viscosity η or greater attenuation. The signal intensity I in this case is plotted in arbitrary units [au] on the y-axis against the transit time t in μs on the x-axis. The lower sonic velocity of the second fluid is reflected in a later arrival of the response signal and a temporally later first arrival Tof2, and the greater viscosity η or greater attenuation in comparison to the fluid 1 under test is reflected in a lower signal amplitude.

The group velocity, i.e. the superposition of different sound phase velocities of viscous media, is further dependent on the frequency of the sound pulse generator 2. The resulting measurement error in determining the sound propagation time or the sonic velocity is less than 1 cm, particularly for measuring cells 5 having a measuring distance 4, because with such short measuring distances 4, it is more feasible to completely evaluate the received signal that arrives at the sound pulse receiver 3. In addition, the measuring error is particularly significant at high viscosities of the fluid 1 under test of greater than 1000 mPa·s.

The shorter the measuring distance is configured to be, the more quickly the evaluation electronics must be able to switch on or record. The currently available evaluation electronics have sampling frequencies that are too low, and do not permit completely recording and evaluating the frequency spectrum for small transit distances.

Surprisingly, despite different effects in the fluid, which lead to the attenuation and broadening of the incoming sound signals, the viscosity η may be used in this case as a first approximation for the correction and sonic velocity over a simple correction table or correction function, the determination of individual values for fluids of known viscosity η (and possibly sonic velocity) are used.

If the measured transit time of the sound pulse between the time of transmission of the sound pulse T0 and the registered first set Tof2 is assigned to the known sonic velocity for the fluid through, for example, a calibration or calibration measurement, it may be seen in FIG. 3 that in the case of a strongly attenuated sound pulse or received signal, the first arrival Tof2 deviates from the actual first arrival Tof′2. From this, it is apparent that the measured first arrival Tof2 differs from the actual first arrival Tof′2 by a quantity ΔTof. The magnitude of the first arrival deviation ΔTof, thus, is dependent on the viscosity η, but also, for example, on the temperature.

In apparatuses and methods known from the prior art for determining a sonic velocity in a fluid 1 under test, this viscosity-induced attenuation is not taken into account.

In an apparatus 10 according to the invention or a method according to the invention for determining a corrected value for the viscosity-dependent sonic velocity in a fluid 1 under test, the measurement error resulting from the viscosity η is corrected when determining the sound propagation time. In this case, for example, a first correction table is provided for the relationship between the viscosity η and the first arrival deviation ΔTof of the first received sound pulse for fluids each having a known viscosity η, and a viscosity η is predetermined or ascertained for the fluid 1 under test.

Subsequently, a correction is made with regard to the viscosity η of the first arrival Tof1, Tof2 of the first received sound pulse for the fluid 1 under test, obtained during measurement; for this purpose, the predetermined or ascertained viscosity η and the first correction table are used. The sonic velocity in the fluid 1 under test is finally determined from the corrected transit time of the first received sound pulse and the predetermined measuring distance 4.

Thus, an exact evaluation of the sound propagation time or the sonic velocity is also assured in measuring cells 5 with measuring distances 4 of less than 1 cm, because with such a small size of the measuring cell 5, the received signal can no longer be fully evaluated by, for example, a Fourier transform of the sound pulse or received signal arriving at the sound pulse receiver 3.

FIG. 6 shows an example of a first correction table for the relationship between the viscosity η and the first arrival deviation ΔTof of the first received sound pulse. In FIG. 6, the first arrival deviation ΔTof is plotted in milliseconds against the root (sqrt) of the viscosity η in mPa·s. In order to generate such a first correction table, preferably at least six fluids are measured and from this, a correction of the first arrival deviation ΔTof is determined. The first arrival deviation ΔTof is dependent on the viscosity η, so that for a certain measured first arrival Tof1, Tof2 at a certain viscosity η of the fluid 1 under test, the error to be corrected may be derived from the stored first correction table.

In order to create the first calibration table, for example, calibration samples are used that have a known sonic velocity. The duration measured for each of the calibration samples between the time T0 at which the sound pulse generator 2 emits a sound pulse, and the first arrival Tof1, Tof2, i.e. the first registered zero crossing of the received signal at the sound pulse receiver 3, is in this case calibrated with the known sound propagation times for the calibration samples, e.g. standard solutions.

This means that the sonic velocity calculated from the transit time of the sound pulse and the measuring distance 4 is compared with the known sonic velocity of the calibration sample, and a viscosity-induced first arrival deviation ΔTof is derived at the known viscosity η of the calibration sample.

Thus, in a method according to the invention, the determined first arrival Tof1, Tof2 for determining the sonic velocity of the fluid 1 under test is corrected by a viscosity-dependent error.

Since the temperature also influences the first arrival deviation ΔTof, in a method according to the invention, optionally, the first correction table may also be provided for the relationship between the viscosity η and the first arrival deviation ΔTof at different temperatures.

The temperature of the fluid under test is determined when measuring the fluid 1 under test, for example by using the sensor 7, and it is subsequently taken into account in correcting the sonic velocity value obtained during measurement, by using the first correction table.

In this case, when preparing the first correction table, preferably at least six calibration samples are measured at preferably at least three different temperatures, and a first correction table is created on that basis, in which the viscosity-related and temperature-related error is taken into account in determining the first arrival deviation ΔTof. Thus, in correcting the first arrival Tof1, Tof2 measured for a fluid 1 under test, the distortion due to viscosity and temperature is corrected.

Alternatively, a model may also be configured so that correction of the first arrival ΔTof is combined with a sonic velocity evaluation.

Alternatively, the sonic velocity in a fluid 1 under test may be determined or derived based on the transit time of the first received sound pulse, by using a first calibration table. For this purpose, a first calibration table for the first arrival Tof1, Tof2 of the first received sound pulse is provided by using calibration measurements of fluids each having a known sonic velocity and known viscosity η. The calibration table is an assignment table in which the respective first arrival Tofi or transit time of a fluid i is assigned to the known sonic velocity of the fluid i. Thus, a corrected value for the sonic velocity may be derived by using the first calibration table, the first arrival Tof1, Tof2 determined for a fluid 1 under test, and the viscosity η ascertained or predetermined for the fluid 1 under test.

The viscosity η required for correcting the first arrival deviation ΔTof or the correction of the sonic velocity is predetermined or ascertained for the fluid 1 under test in an apparatus 10 according to the invention or in a method according to the invention. In the apparatus 10 shown in FIG. 1, for example, a known viscosity η or a known viscosity range η is predetermined for the fluid 1 under test and input, for example, at the evaluation unit 6.

Alternatively, a database of known viscosities η or viscosity ranges η may be provided for fluids 1 under test, and the viscosity η or a known viscosity range η for the fluid 1 under test may be ascertained in the database. Such a database of known viscosities η or value ranges of the viscosity η for different fluids may be stored, for example, in the evaluation unit 6.

Alternatively, the viscosity η for the fluid 1 under test may be ascertained by using a measuring method for determining the viscosity η, in particular by using a flexural resonator. For this purpose, for example, a measuring apparatus for determining the viscosity η is combined with an apparatus 10 according to the invention; or a further evaluation unit of a measuring apparatus for determining the viscosity η is connected to the evaluation unit 6, so that viscosity measurements for the fluid 1 under test are sent to the evaluation unit 6 of the apparatus 10.

Alternatively, in a method according to the invention or an apparatus 10 according to the invention, the viscosity η for the fluid under test may also be determined approximately directly by determining the pulse width of the first incoming sound pulse at the sound pulse receiver 3, or of the received signal.

The pulse width P, P1, P2 of the first received sound pulse is ascertained as the full width at half maximum of the first incoming sound pulse, by a known and preferred method, as shown in FIG. 4 for the first fluid 1 under test. In FIG. 4, the signal intensity I is plotted in arbitrary units [a.u.] on the y-axis against the transit time t in μs on the x-axis. In this case, the full width at half maximum indicates the full width of the signal received at the sound pulse receiver 3 at half the maximum deflection. This has the advantage that it is not necessary to exactly evaluate the difficult-to-determine start signal, i.e. the time when receiving the sound pulse, and thus a second calibration table may easily be created, which indicates the previously-ascertained relationship between the viscosity η and the pulse width P, P1, P2.

Alternatively, the pulse width P, P1, P2 of the first received sound pulse may be determined as the time interval between the start signal, i.e. the time of first receiving the sound pulse, and the first registered zero crossing of the sound pulse.

The pulse width P, P1, P2 in this case is a function of attenuation by the fluid 1 under test, the excitation frequency of the sound pulse generator 2, the temperature and the viscosity η of the fluid 1 under test. In this case, the excitation frequency of the sound pulse generator 2 and the measuring distance 4 are constant and the only variable quantity is the viscosity η, as the temperature is assumed to be constant.

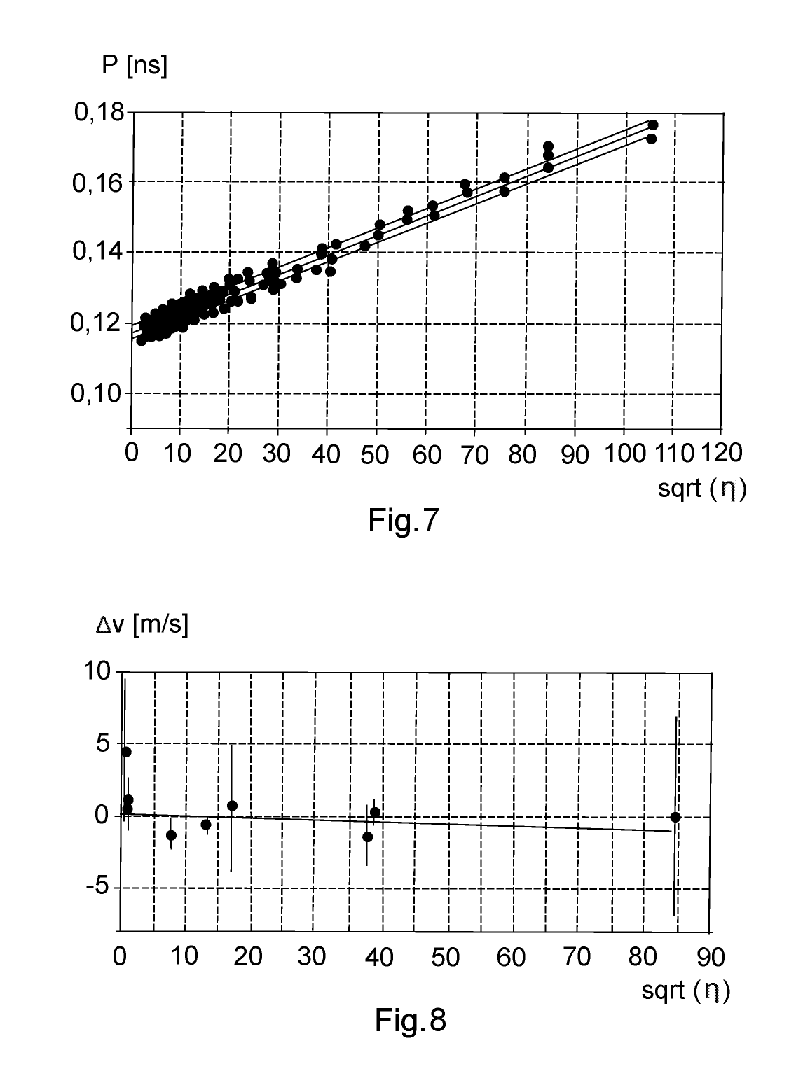

FIG. 7 shows the relationship between the pulse width P in nanoseconds and the root (sqrt) of the viscosity η. It is evident that the sound pulse arriving at the sound pulse receiver 3 is more strongly attenuated by the same stimulation pulse of the sound pulse generator 2 when it propagates in more viscous media than in less viscous media. This circumstance leads on one hand to a decrease in the signal amplitude and, on the other hand, to an increase in the pulse width P, P1, P2.

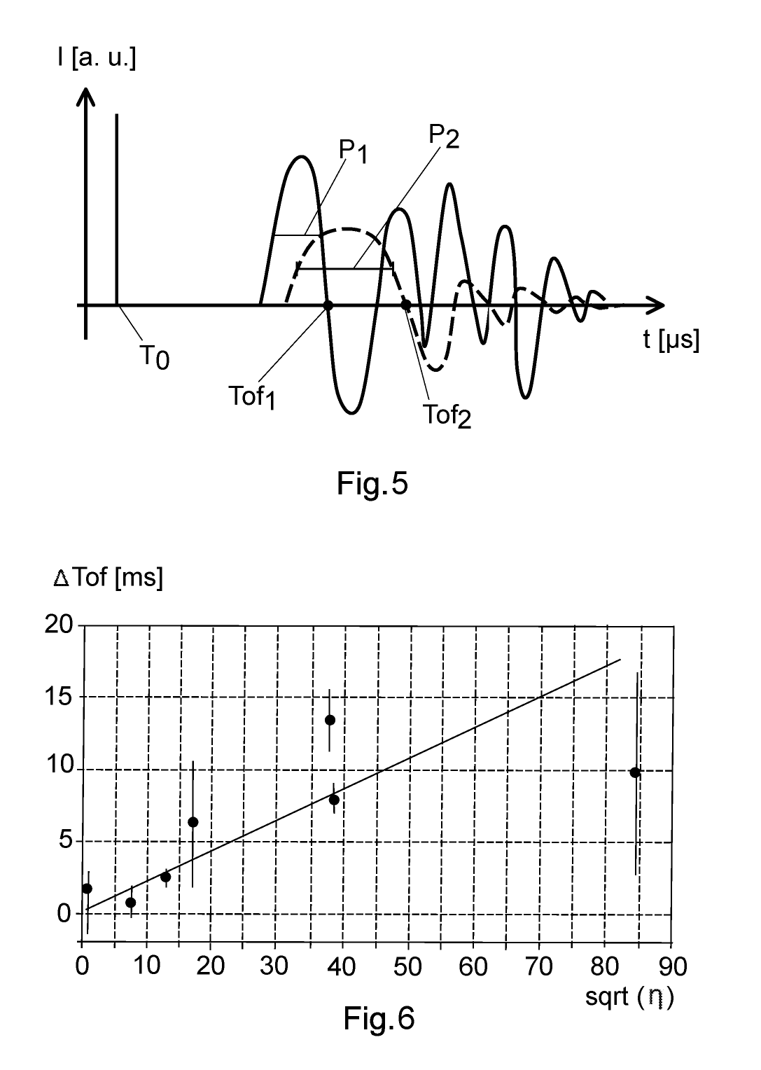

This may also be seen in FIG. 5, where the signal intensity I is plotted in arbitrary units [a.u.] on the y-axis against the transit time t in μs on the x-axis, and the pulse width P1 of the first registered sound pulse of the fluid 1 under test is smaller and the signal amplitude is higher than the pulse width P2 and the signal amplitude of the other fluid.

In order to determine the viscosity η from the pulse width P, P1, P2, a second calibration table for is provided for the relationship between the viscosity and the pulse width P, P1, P2 of the first sound pulse received after traversing the measuring distance 4, for a multiplicity of fluids each having a known viscosity η. An example of such a second calibration table or calibration function is shown in FIG. 7.

The pulse width P of the first sound pulse received in the fluid 1 under test after traveling the measuring distance 4 is subsequently determined, and the viscosity of the fluid 1 under test is determined by using the second calibration table or calibration function and the ascertained pulse width P of the first received sound pulse.

As may be seen in FIG. 7, the pulse width P changes as a function of the viscosity η and increases with increasing viscosity η. The pulse width change causes a first-time offset ΔTof. This first arrival deviation ΔTof may be corrected with knowledge of the viscosity η, as described above, for a certain type of measuring cell with a known measuring distance 4 and a constant excitation frequency of the sound pulse generator 2, for example, by using the correction table.

Optionally, the two steps, i.e., the determination of the viscosity η of the fluid under test by using the pulse width P, P1, P2 and the determination of the first arrival deviation ΔTof based on the ascertained viscosity η of the fluid 1 under test, may also be stored in a single common correction table or as a common correction function. In an evaluation step, such a common correction table or correction function yields the viscosity-induced first arrival deviation ΔTof, starting from the pulse width P, P1, P2 determined for the fluid under test, which must be taken into account when ascertaining the sonic velocity in the fluid under test.

In order to generate this common correction table, a multiplicity of correction measurements are conducted on preferably at least six samples each having a known viscosity η and sonic velocity. A higher-order polynomial is normally required in order to describe the relationship between the first arrival deviation ΔTof and the viscosity η derived from the pulse width P, P1, P2. Preferably, for example, for at least 6 or more samples, known viscosity η and sonic velocity are necessary in order to enable description by using a second-order polynomial.

Alternatively, a common correction table or correction function may be created from the first calibration table, which indicates the first arrival Tof1, Tof2 of the first received sound pulse for fluids each having a known sonic velocity and known viscosity η, and the second calibration table, which indicates the relationship between the viscosity η and the pulse width P; P1, P2 for fluids each having a known viscosity η.

Thus, a corrected viscosity-dependent sonic velocity may be determined straightforwardly by using the common correction table and the first arrival Tof1, Tof2 of the first received sound pulse and ascertained pulse width P; P1, P2 for the fluid 1 under test.

Optionally, the temperature of the samples may be taken into consideration, with a corresponding polynomial expression and calibration measurement in the common correction table or common correction function.

Optionally, the temperature during measurement of the fluid 1 under test may be measured and taken into account in correcting the first arrival Tof1, Tof2. The correction of the first arrival or the correction of the specific transit time for the fluid 1 under test is thus viscosity-dependent and temperature-dependent; to evaluate the sonic velocity, both quantities may be obtained from either measurement or known reference values.

FIG. 8 shows a representation of the sonic velocity deviation Δv in meters per second plotted against the root (sqrt) from the viscosity η for fluids under test 1 with known sound velocities, for which a correction based on the viscosity η was applied in evaluating the sonic velocity. In this case, the viscosity η was determined from the pulse width P of the first sound pulse that was received after it had traversed the measuring distance 4 for the respective fluid. It may be seen in FIG. 8 that taking into account the viscosity-related first-time application deviation, results in a significant improvement in the ascertained measurements for the sonic velocity in the fluids under test 1.

Alternatively, an apparatus 10 according to the invention may also be configured in such a way that the sound pulse generator 2 and the sound pulse receiver 3 are configured as a combined sound pulse generator/receiver, the sound pulse generator/receiver being disposed at one end of the measuring distance 4. A sound-reflecting boundary surface is disposed at the far end of the measuring distance 4, opposite the sound pulse generator/receiver, and the sound pulse generator/receiver may be induced to emit sound pulses upon registering incoming sound pulses. In other words, the sound pulses that the combined sound pulse generator/receiver emits are incident on the solid-fluid interface, and are subsequently registered by the combined sound pulse generator/receiver, and after these sound pulses are registered, a new sound pulse is transmitted. Combined piezoelectric ultrasonic transducers/receivers are a suitable example of a combined sound pulse generator/receiver.

Thus, only the component of the sound pulse reflected at the boundary surface is used to evaluate the sonic velocity. Advantages of an apparatus 10 configured in this manner are that the sound pulse propagates only in a fluid 1 under test and does not pass through a solid-fluid-solid layer sequence.

As a result, the sound propagation times or sonic velocities determined by such an apparatus 10 are characterized by high resolution and repeatability, and the measurement is immediately sensitive to changes in concentration or temperature, so that drift-free measurement results may be obtained in real time. Furthermore, the construction of such a measuring cell 5 is robust and requires fewer moving parts. Such a configuration of an apparatus 10 according to the invention is particularly suitable for strongly absorbing fluids 1 under test, because in this case, the multiple reflections are greatly reduced and do not interfere with determining the first arrival Tof1, Tof2 in the fluid 1 under test.

Alternatively, each apparatus 10 according to the invention may also be configured to be thermostatted, so that the temperature remains constant during measurement and therefore the temperature need not be taken into account in correcting the viscosity-dependent sonic velocity.

1. A method for determining a corrected value for a viscosity-dependent sonic velocity in a fluid under test, the method comprising the following steps:
generating and transmitting sound pulses to the fluid under test;
registering the sound pulses after traversing a predetermined measuring distance in the fluid under test;
obtaining a first arrival of a first sound pulse received after traversing the measuring distance, and determining a transit time of the first received sound pulse in the fluid under test;
predetermining or ascertaining a viscosity for the fluid under test; and
using the transit time of the first received sound pulse and the viscosity to determine the sonic velocity in the fluid under test.

2. The method according to claim 1, which further comprises:
preparing a first correction table for a relationship between the viscosity and a first arrival deviation of the first received sound pulse, for fluids having a respectively known viscosity;
correcting the first arrival of the first received sound pulse when measuring the fluid under test with regard to the viscosity, by using the first correction table and the predetermined or ascertained viscosity; and
calculating the sonic velocity in the fluid under test from a corrected transit time of the first received sound pulse and the predetermined measuring distance.

3. The method according to claim 2, which further comprises:
preparing a first calibration table for the first arrival of the first received sound pulse for fluids each having a known sonic velocity and known viscosity; and
using the first arrival of the first received sound pulse and the predetermined or ascertained viscosity for determining the sonic velocity in the fluid under test, by using the first calibration table.

4. The method according to claim 1, which further comprises ascertaining the first arrival of the first received sound pulse as:
a first zero crossing of the sound pulse after a first registered maximum of the sound pulse, or
a first registered arrival of the sound pulse, or
a peak position of a first maximum of the first registered sound pulse.

5. The method according to claim 1, which further comprises:
predetermining a known viscosity or a known viscosity range for the fluid under test; or
providing a database of known viscosities or viscosity ranges for fluids, and ascertaining the viscosity or a known viscosity range in the database for the fluid under test.

6. The method according to claim 1, which further comprises ascertaining the viscosity for the fluid under test by using a measurement method for determining the viscosity.

7. The method according to claim 6, which further comprises using a flexural resonator in the method for determining the viscosity.

8. The method according to claim 3, which further comprises:
preparing a second calibration table for fluids each having a known viscosity, reflecting a relationship between the viscosity and a pulse width of the first sound pulse received after traversing the measuring distance;
ascertaining the pulse width of the first sound pulse received after traversing the measuring distance in the fluid under test; and
determining the viscosity of the fluid under test by using the second calibration table and the ascertained pulse width of the first received sound pulse.

9. The method according to claim 8, which further comprises ascertaining the pulse width of the first received sound pulse from:
a time period between first receiving the sound pulse and a first registered zero crossing of the sound pulse, or
a full width at half maximum of the first received sound pulse.

10. The method according to claim 3, which further comprises:
preparing either the first correction table for the relationship between the viscosity and the first arrival deviation, or the first calibration table for the first arrival of the first received sound pulse for fluids each having a known sonic velocity and known viscosity, for different temperatures;
ascertaining the temperature of the fluid under test during measurement; and
taking the temperature into account in correcting the sonic velocity value obtained by measurement by using the first correction table or the first calibration table.

11. The method according to claim 8, which further comprises:
using the first correction table for the relationship between the viscosity and the first arrival deviation and the second calibration table for the relationship between the viscosity and the pulse width, to establish a common correction table, by
ascertaining the first arrival deviation by using the ascertained pulse width for the fluid under test and the common correction table, and
calculating the sonic velocity in the fluid under test from the corrected transit time of the first received sound pulse and the predetermined measuring distance, or
using the first calibration table for the first arrival of the first received sound pulse for fluids of known sonic velocity and known viscosity and the second calibration table for the relationship between the viscosity and the pulse width for fluids with respectively known viscosity, to create a common correction table, by
using the first arrival of the first received sound pulse determined for the fluid under test and then the pulse width determined for the fluid under test, to determine the sonic velocity by using the common correction table.

12. The method according to claim 1, which further comprises setting at least one of the viscosity of the fluid under test to be greater than 1000 mPa·s or the measuring distance to be less than 1 cm.

13. An apparatus for determining a corrected value for a viscosity-dependent sonic velocity in a fluid under test, the apparatus comprising:
a sound pulse generator for emitting sound pulses and a sound pulse receiver for registering incoming sound pulses;
a measuring cell defining a predetermined measuring distance in said measuring cell between said sound pulse generator and said sound pulse receiver; and
an evaluation unit connected to said sound pulse generator and to said sound pulse receiver, said evaluation unit being configured to:
generate and transmit sound pulses to the fluid under test;
register the sound pulses after traversing said measuring distance,
obtain a first arrival of a first sound pulse received after traversing the measuring distance, and determine a transit time of the first received sound pulse in the fluid under test,
predetermine or ascertain a viscosity for the fluid under test, and
use the transit time of the first received sound pulse and the viscosity to determine the sonic velocity in the fluid under test.

14. The apparatus according to claim 13, which further comprises a sensor connected to said evaluation unit for determining a temperature of the fluid under test.

15. The apparatus according to claim 14, wherein:
said sound pulse generator and said sound pulse receiver are configured as a combined sound pulse generator/receiver disposed at one end of said measuring distance;
a sound-reflecting interface is disposed opposite said sound pulse generator/receiver at another end of said measuring distance; and
said sound pulse generator/receiver is configured to be excited by the registration of incoming sound pulses to emit sound pulses.
